(19) United States
(12) Patent Application Publication
(10) Pub. No.: US 2016/0352178 A1
(43) Pub. Date: Dec. 1, 2016

(54) ASSISTANCE DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHEN-CHING CHU, New Taipei (TW); YU-NING WANG, New Taipei (TW); CHENG-KUO LEE, New Taipei (TW); MING-KUN ZHONG, Shenzhen (CN); JIAN-FENG SUN, Shenzhen (CN)

(21) Appl. No.: 14/838,111

(22) Filed: Aug. 27, 2015

(30) Foreign Application Priority Data
May 29, 2015 (CN) 201510285431.1

(51) Int. Cl. H02K 5/04; H02K 1/06; H02K 3/28; H02J 7/00

(52) U.S. Cl. CPC H02K 5/04; H02J 7/0044; H02J 7/007; H02K 1/06; H02K 3/28

(57) ABSTRACT

An assistance device includes a main body, a first permanent magnet, a second permanent magnet, a coil, and a supporting arm. The main body can be configured to support an electronic device. The main body defines a receiving space. The first permanent magnet and the second permanent magnet are fixed in the receiving space. The second permanent magnet and the first permanent magnet cooperatively form a magnetic field. The coil is rotatably received in the receiving space. The supporting arm is fixed to the coil and rotatably coupled to the main body. The supporting arm is steady with respect to the surface when the main body is rotated with respect to the surface. The first permanent magnet and the second permanent magnet rotate with respect to the coil. The coil generates power for the electronic device at the coil goes through the magnetic field.

### CROSS-REFERENCE TO RELATED APPLICATIONS

This application claims priority to Chinese Patent Application No. 201510285431.1 filed on May 29, 2015, the contents of which are incorporated by reference herein.

### FIELD

The subject matter herein generally relates to assistance devices, and particularly, to an assistance device capable of generating power for an electronic device.

### BACKGROUND

Power banks are commonly employed to charge electronic devices. However, the power banks must be charged to generate power.

### BRIEF DESCRIPTION OF THE DRAWINGS

Implementations of the present technology will now be described, by way of example only, with reference to the attached figures, wherein:

FIG. 1 is an isometric view showing an embodiment of an assistance device and an electronic device.

FIG. 2 illustrates an isometric view of the assistance device of FIG. 1, but viewed from bottom of the assistance device.

FIG. 3 illustrates an exploded, isometric view of the assistance device of FIG. 2.

FIG. 4 is a cross-sectional view of the assistance device of FIG. 1 receiving the electronic device.

FIG. 5 is a plan view of the assistance device of FIG. 2 showing hidden components.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

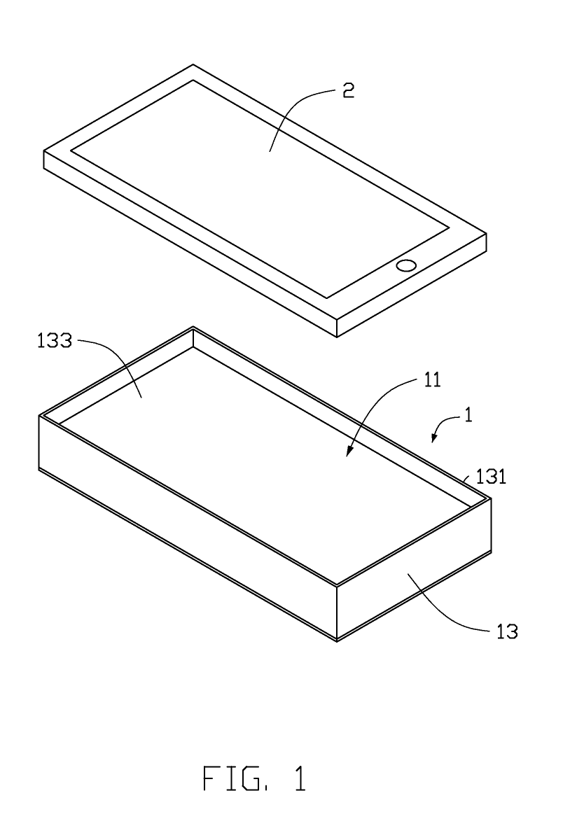

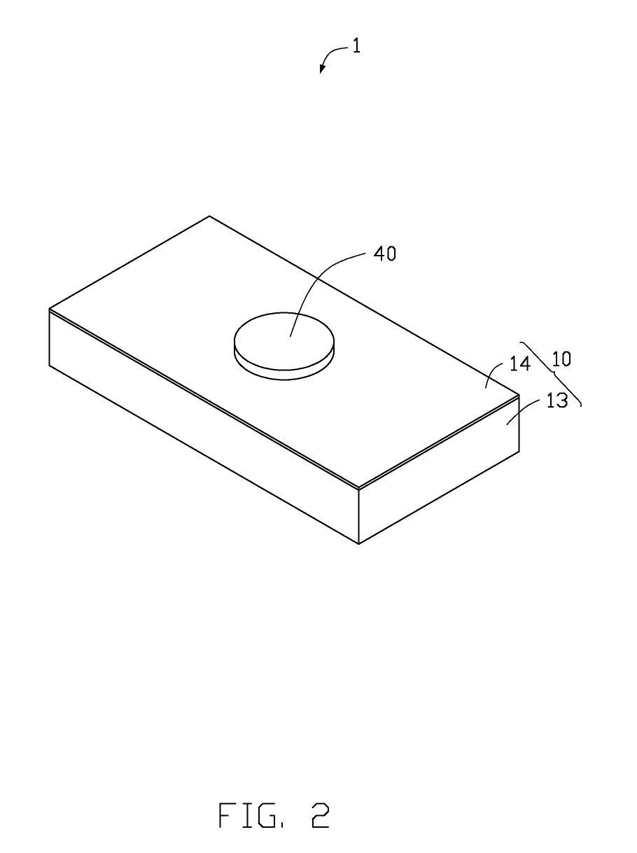

FIG. 1 illustrates a view of an embodiment of an assistance device 1 and an electronic device 2. The assistance device 1 can generate power for the electronic device 2. FIG. 2 illustrates an isometric view of the assistance device 1, but viewed from a bottom of the assistance device 1. The assistance device 1 can include a main body 10. The main body 10 can be configured to position and support the electronic device 2.

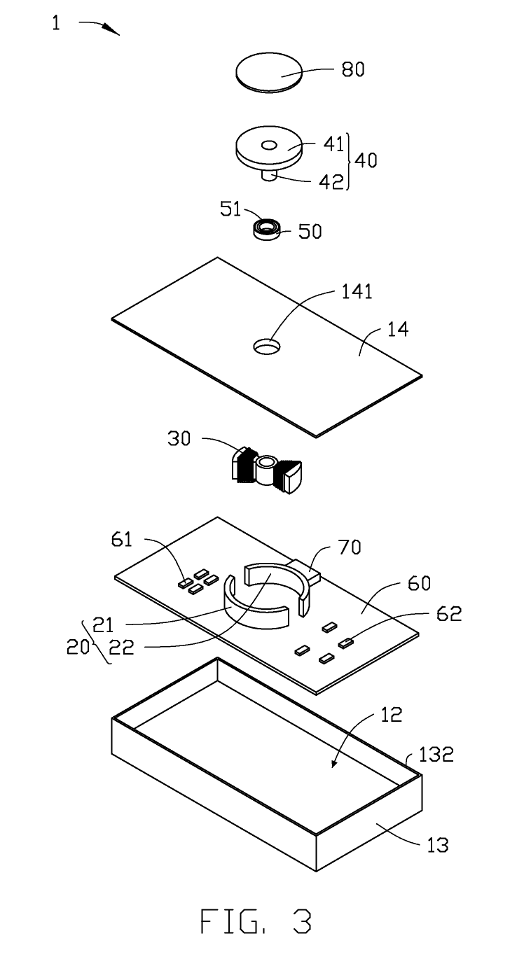

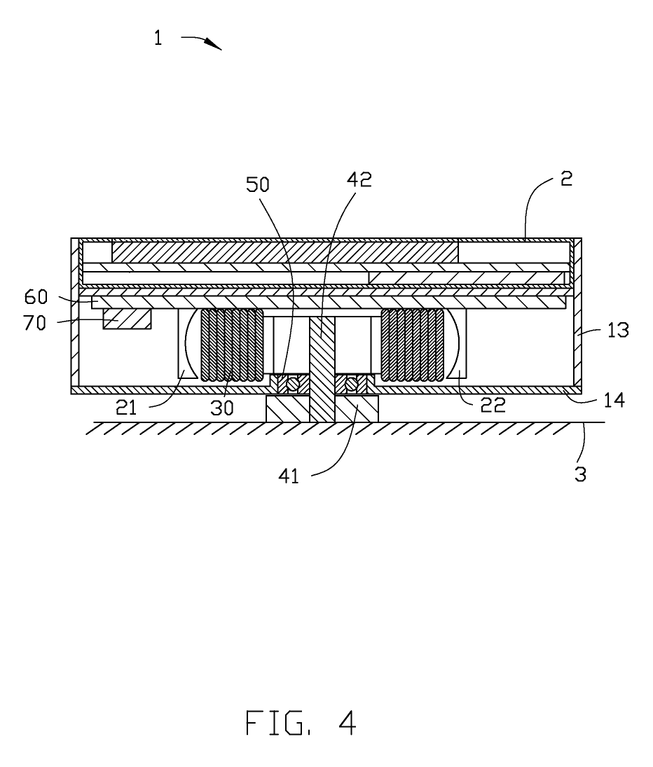

FIGS. 3-4 illustrate views of the assistance device 1. The assistance device 1 can further include a pair of permanent magnets 20, at least one coil 30, and a supporting arm 40. The pair of the permanent magnets 20 can be fixed in the main body 10. The pair of the permanent magnets 20 can be configured to generate a magnetic field which is represented by a number of magnetic field lines. The at least one coil 30 can be rotatably received in the main body 10. The supporting arm 40 can be fixed to the at least one coil 30, and rotatably coupled to the main body 10. The main body 10 can rotate relative to the supporting arm 40, when the main body 10 is rotated, causing the at least one coil 30 to cut magnetic field lines in the magnetic field. Thus, the assistance device 1 can generate power for the electronic device 2. In at least one embodiment, the lines connected between the assistance device 1 and the electronic device 2 can be omitted herein.

In at least one embodiment, the main body 10 can define a receiving groove 11 and a receiving space 12. In at least one embodiment, the receiving groove 11 can be configured to receive the electronic device 2. The receiving groove 11 can be replaced by any other suitable devices, such as an elastic band, to attach the electronic device 2 to the main body 10. The receiving space 12 can be configured to receive the pair of the permanent magnets 20 and the at least one coil 30.

In at least one embodiment, the pair of the permanent magnets 20 can be fixed in the receiving space 12. In at least one embodiment, the pair of the permanent magnets 20 can include a first permanent magnet 21 and a second permanent magnet 22. The second permanent magnet 22 can face the first permanent magnet 21 and be separated from the first permanent magnet 21. The first permanent magnet 21 and the second permanent magnet 22 can cooperatively form the magnetic field represented by the number of magnetic field lines.

In at least one embodiment, one coil 30 can be taken as an example. In at least one embodiment, the coil 30 can be annular. The coil 30 can be rotatably received in the receiving space 12 and arranged between the first permanent magnet 21 and the second permanent magnet 22. The coil 30 can generate power for the electronic device at the coil goes through the magnetic field.

In at least one embodiment, the supporting arm 40 can be partially exterior to the main body 10. The supporting arm 40 can be fixed to the coil 30 and rotatably coupled to the main body 10. In at least one embodiment, the supporting arm 40 can be configured to solely support the main body 10 and the electronic device 2 above a surface 3 when the supporting arm 40 is arranged on the surface 3.

To generate power for the electronic device 2, the supporting arm 40 can be arranged on the surface 3. The supporting arm 40 can solely support the main body 10 and the electronic device 2 above the surface 3. The main body 10 can rotate relative to the surface 3 when a force is exerted on the main body 10. The supporting arm 40 can be still with respect to the surface 3. The first permanent magnet 21 and the second permanent magnet 22 can rotate relative to the coil 30. The coil 30 can cut the magnetic field lines in the magnetic field. Thus, the assistance device 1 can generate power for the electronic device 2.

In at least one embodiment, the main body 10 can include a first main body 13 and a second main body 14. The first main body 13 can define the receiving groove 11 and the receiving space 12. In at least one embodiment, the first main body 13 can include a first surface 131 and a second surface 132 opposite to the first surface 131. In at least one embodiment, the first surface 131 of the first main body 13 can be an upper surface of the first main body 13 and the second surface 132 of the first main body 13 can be a lower surface of the first main body 13. The receiving groove 11 can extend from the first surface 131 of the first main body 13 to the second surface 132 of the first main body 13. The receiving space 12 can extend from the second surface 132 of the first main body 13 to the first surface 131 of the first main body 13. The receiving groove 11 and the receiving space 12 can be spaced from each other via a bottom 133 of the receiving groove 11. The second main body 14 can be fixed to the first main body 13 at the receiving space 12. In at least one embodiment, the second main body 14 can be fixed to the first main body 13 via screw, welding, or any other suitable ways.

In at least one embodiment, the second main body 14 can define a first through hole 141. The first through hole 141 can be coupled to the receiving space 12. The assistance device 1 can include a bearing 50. The bearing 50 can be fixed in the first through hole 141. The bearing 50 can define a second through hole 51. The second through hole 51 can be coupled to the receiving space 12. In at least one embodiment, the second through hole 51 and the first through hole 141 can be axial. The supporting arm 40 can be partially fixed in the second through hole 51. Thus the supporting arm 40 can be rotatably coupled to the second main body 14 via the bearing 50.

In at least one embodiment, the first permanent magnet 21 can have a first polarity and the second permanent magnet 22 can have a second polarity opposite to the first polarity. In at least one embodiment, the first polarity can be a north polarity and the second polarity can be a south polarity. In other embodiments, the first polarity can be a south polarity and the second polarity can be a north polarity.

In at least one embodiment, the supporting arm 40 can include a supporting member 41 and an axis 42. The supporting member 41 can be exterior to the second main body 14. The axis 42 can be fixed to the supporting member 41. In at least one embodiment, the axis 42 can be substantially perpendicular to the supporting member 41. The axis 42 can be fixed in the second through hole 51 of the bearing 50 and be fixed to the coil 30. In at least one embodiment, the supporting member 41 can be configured to support the main body 10 and the electronic device 2 above the surface 3 when the supporting member 41 is arranged on the surface 3.

In at least one embodiment, the assistance device 1 can further include a printed circuit board (PCB) 60 and a battery 70. The PCB 60 and the battery 70 can be fixed in the receiving space 12. The PCB 60 can be electrically coupled to the coil 30 and the battery 70. The PCB 60 can include a control circuit 61. The control circuit 61 can be configured to store the generated power to the battery 70. In at least one embodiment, the control circuit 61 can further be configured to control the battery 70 to charge the electronic device 2. In at least one embodiment, the battery 70 can be a rechargeable battery.

In at least one embodiment, the PCB 60 can further include a transforming circuit 62. The transforming circuit 62 can be electrically coupled to the control circuit 61. The transforming circuit 62 can be configured to boost or buck the voltage of the generated power to a predetermined value (such as 5 volts). The control circuit 61 can be configured to supply the boosted or bucked voltage to the electronic device 2. In at least one embodiment, the control circuit 61 can be configured to detect whether an electronic device 2 is coupled to the PCB 60. The control circuit 61 can be configured to supply the boosted or bucked voltage to the electronic device 2 when the electronic device 2 is electrically coupled to the PCB 60. The control circuit 61 can be further configured to store the generated power to the battery 70 when the electronic device 2 is electrically uncoupled to the PCB 60.

In at least one embodiment, the supporting arm 40 can further include an anti-slip member 80. The anti-slip member 80 can be fixed to an end of the supporting member 41 away from the second main body 14. In at least one embodiment, the anti-slip member 80 can be made of silicone material, ethylene-vinyl acetate copolymer material, polyvinyl chloride material, or the like. The anti-slip member 80 can be configured to increase a friction between the supporting arm 40 and the surface 3, thus the supporting arm 40 can be steady with respect to the surface 3 when the main body 10 is rotated with respect to the surface 3. In an alternative embodiment, the supporting member 41 can be made of silicone material, ethylene-vinyl acetate copolymer material, polyvinyl chloride material, or the like. Thus, the friction between the supporting arm 40 and the surface 3 can cause the supporting arm 40 to be still with respect to the surface 3 when the main body 10 rotates with respect to the surface 3. In other embodiments, the anti-slip member 80 can be replaced by other mechanical structures, such as suction cup, to make the supporting arm 40 steady with respect to the surface 3 when the main body 10 is rotated with respect to the surface 3.

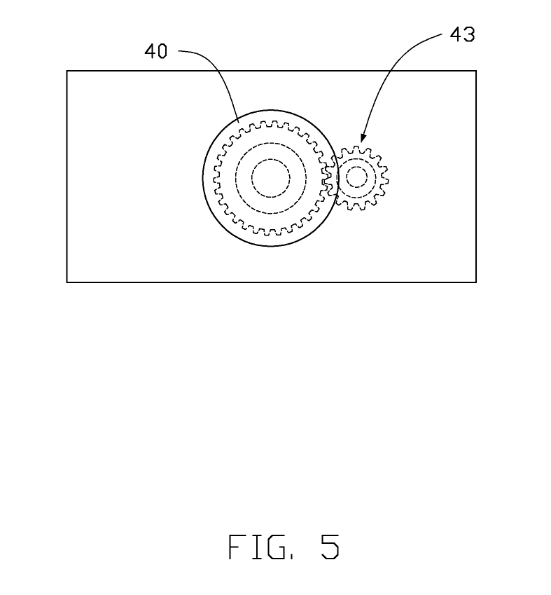

FIG. 5 illustrates a plan view of the assistance device showing hidden components. In at least one embodiment, the axis 42 can be fixed to the coil 30 via a gear transmission 43 represented by dashed lines. Thus, the first permanent magnet 21 and the second permanent magnet 22 can rotate at least one cycle with respect to the coil 30 when the main body 10 rotates one cycle with respect to the supporting arm 40. In at least one embodiment, the at least one cycle can be 1 cycle, 1.5 cycles, 5 cycles, or any other number of cycles greater than one.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An assistance device comprising:
a main body configured to support an electronic device and defining a receiving space;
a first permanent magnet fixed in the receiving space;
a second permanent magnet fixed in the receiving space and facing and separated from the first permanent magnet; the second permanent magnet and the first permanent magnet cooperatively forming a magnetic field;
at least one coil rotatably received in the receiving space and arranged between the first permanent magnet and the second permanent magnet; and
a supporting arm partially exterior to the main body and being fixed to the at least one coil; the support arm rotatably coupled to the main body and being configured, when the supporting arm is arranged on the surface, to support the main body and the electronic device above a surface;
wherein, when the main body is rotated with respect to the surface, the supporting arm is steady with respect to the surface and the first permanent magnet and the second permanent magnet rotate with respect to the at least one coil, whereby the at least one coil generates power for the electronic device at the at least one coil goes through the magnetic field.

2. The assistance device as described in claim 1, wherein:
the magnetic field formed by the first permanent magnet and the second permanent magnet is represented by a plurality of magnetic field lines; and
the at least one coil cuts the magnetic field lines in the magnetic field to generate power for the electronic device.

3. The assistance device as described in claim 1, wherein:
the first permanent magnet has a first polarity, and the second permanent magnet has a second polarity opposite to the first polarity.

4. The assistance device as described in claim 1, wherein:
the main body comprises a first main body and a second main body;
the first main body comprises a first surface and a second surface opposite to the first surface, the receiving space extends from the second surface of the first main body to the first surface of the first main body; and
the second main body is fixed to the first main body at the receiving space.

5. The assistance device as described in claim 4, wherein:
the first main body defines a receiving groove extending from the first surface of the first main body to the second surface of the first main body, the receiving groove and the receiving space are spaced from each other via a bottom of the receiving groove.

6. The assistance device as described in claim 1, further comprising a bearing, wherein:
the main body defines a through hole, the bearing is fixed in the through hole, the supporting arm is partially fixed in the bearing, thereby be rotatably coupled to the main body via the bearing.

7. The assistance device as described in claim 6, wherein:
the supporting arm comprises a supporting member and an axis, the supporting member is exterior to the main body, the opposite ends of the axis are respectively fixed to the supporting member and the at least one coil, the axis is fixed in the bearing.

8. The assistance device as described in claim 1, further comprising a control circuit and a battery, wherein:
the control circuit and the battery are fixed in the receiving space, the control circuit is electrically coupled to the at least one coil and the battery, the control circuit is configured to store the generated power to the battery.

9. The assistance device as described in claim 1, further comprising a transforming circuit and a control circuit, wherein:
the transforming circuit and the control circuit are fixed in the receiving space, the transforming circuit is electrically coupled to the at least one coil and the control circuit, the transforming circuit is configured to boost or buck voltage of the generated power to a predetermined value, the control circuit is configured to supply the boosted or bucked voltage to the electronic device.

10. The assistance device as described in claim 1, further comprising an anti-slip member, wherein:
the anti-slip member is fixed to an end of the supporting arm away from main body, the anti-slip member is configured to increase a friction between the supporting arm and the surface, thus the supporting member is configured to be steady with respect to the surface when the main body is rotated with respect to the surface.
